(19) United States
(12) Patent Application Publication
(10) Pub. No.: US 2003/0179487 A1
(43) Pub. Date: Sep. 25, 2003

(54) Static head design for computer hard drives

(76) Inventor: Christopher G. Wagner, Highlands Ranch, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/103,472

(22) Filed: Mar. 20, 2002

(51) Int. Cl. G11B 17/00

(52) U.S. Cl. 360/97.01

(57) ABSTRACT

A hard disk drive uses a set of static “read/write head platters” fitting between media platters in the hard drive assembly. The static read/write platters include a number of read/write heads arranged in a predetermined pattern on both sides of the platter. The media platters are rotated so that the read/write heads are positioned over corresponding tracks of the drive media. The top and bottom read/write platters have read/write heads on one side only since they communicate with only one media platter. Each read/write platter is rectangular and is secured to a frame. The edge of each read/write platter also includes built-in circuitry for handling the read write requests for that particular platter. Each platter sub system cooperates with a master read/write unit that coordinates the proximity of reads in order to minimize interference.

### FIELD OF THE INVENTION

This invention is related to hard disk drives, and, more particularly, to an improved “static head” design.

### BACKGROUND OF THE INVENTION

Hard disk drives are common in the computer industry. In a typical hard disk drive, read/write heads are spring-loaded airfoils that fly above or below the surface of media platters at a distance measured in micro-inches. This basic hard disk drive mechanism was introduced in the Winchester hard disk drive invented by IBM in 1973. Read/write heads are small electromagnets about one mm square. Information is stored on the media platters by sending pulses of current from the drive electronics to the read/write head. The direction of the current and thus the direction of the diverging magnetic field across the gap in the head determines the direction of the magnetic domains on a particular spot on the platter's magnetic coating, and, thus, whether the spot represents a binary one or zero. The magnetic domains retain their directional polarity vector until they are re-written by the corresponding drive electronics.

In a typical hard disk drive, the read/write heads are bonded to a metal suspension (or head arm), which is a small arm that holds the read/write head in position above or beneath a disk. A head and suspension is called a head-gimbal assembly or HGA. The HGA's are stacked together into a head-stack assembly, which is propelled across the disk surface by an actuator. The actuator on most recent hard disks employs a voice coil mechanism. The voice coil consists of a curved magnet and a spring-loaded coil of fine wire which is attached to the read/write heads by head arms. The head arms are attached to, and pivot about an actuator shaft. When the drive electronics apply an electric current to the actuator coil, the coil interacts with the magnet and swings against the actuator spring. The heads rotate around the actuator shaft in the opposite direction of the coil movement, inward and outward from the center to the edges of the media platters.

During a power outage, the spring, which counterbalances the electromagnetic force between the coil and magnet, takes over and automatically parks and locks the read/write heads. The heads are placed on a part of the media platters called a landing zone before they can crash on, and mar any part of the surface where data is stored. When power is restored, the platters speedup and the heads take off and start flying again.

While the “Winchester” type hard disk drive has been a staple in the computer industry for thirty years, there are certain disadvantages with this mechanism. The disk drive has a high number of mechanical parts, and is therefore subject to mechanical breakdown. The typical disk drive assembly is also subject to damage from G-forces. Also, the very nature of the structure imposes a limit on the “seek time” required to access data. While the seek time of current disk drives is sufficient for current needs, the performance of the current disk drive mechanism may not be able to sustain future data storage and retrieval requirements.

What is desired, therefore, is a new disk drive assembly that can increase the mean time between failures (MTBF) of current disk drives, is less susceptible to G-forces, and minimizes seek time below that which is available today with current disk drive assemblies.

### SUMMARY OF THE INVENTION

According to the present invention a hard disk drive eliminates the standard “Winchester”-type read/write heads by using static “read/write head platters” that fit between the media platters in the hard drive itself. The static platters include a number of read/write heads arranged in a pattern on both sides of the platter. The media platters are rotated so that the read/write heads are positioned over the corresponding tracks of the drive media. The top and bottom read/write platters have read/write heads on one side only since they communicate with only one media platter. Each read/write platter is ideally rectangular in order to be secured to a frame and is thus stationary while the media platters spin in between the read/write platters. The edge of each read/write platter also includes built-in circuitry for handling the read/write requests for that particular platter. Each platter sub-system cooperates with a master read/write unit that coordinates the proximity of reads in order to minimize interference.

On each read/write platter there is a multiplicity of read/write heads arranged in a specific pattern to minimize signal interference if read/writes occur on either side of the read/write platter. Two sets of heads can be used in conjunction, but can also be used as protection from head failure by providing a backup read/write head to access a desired track on a desired media platter if needed.

It is an object of the present invention to replace the read/write arms in a conventional “Winchester”-type hard disk drive.

It is a feature of the hard disk drive of the present invention that, since the read/write arms are eliminated, the drive assembly can be made to higher tolerances, which decreases the number of moving parts and increase the meantime-between-failure (MTBF).

It is a feature of the present invention that the media platters are surrounded by “read/write” platters that allows for precise placement of the read/write heads.

It is an advantage of the hard disk drive of the present invention that it has the ability to read and write on different tracks on different media platters at the same time, which markedly speeds up performance.

It is an advantage of the present invention that reads are allowed on multiple parts of the disk and writes are allowed on multiple parts of the disk at the very same time, thus reducing seek time.

It is a further advantage of the present invention that the drive assembly is more robust and is able to withstand higher G-shocks than conventional designs.

It is a further advantage of the present invention that Winchester-specific problems such as head drift, head crash, and parking the head are substantially reduced or eliminated because there is one read/write head per track per disk on each side of the read/write platter.

The foregoing and other features of the present invention are described in further detail below and set forth in the appended claims.

### BRIEF DESCRIPTION OF THE DRAWINGS

FIG. 1 is a side angle view of a simplified version of the static head assembly of the present invention showing three static read/write platters, interleaved with three rotating media platters;

FIG. 2 is a plan view showing a read/write platter in greater detail;

FIG. 3 is a plan view of a read/write platter showing a track and read/write head placement example wherein a non moving read/write drive head is placed directly above or below a track on a moving hard drive media platter to allow for very quick retrieval of data and placing of data on the hard drive media platter;

FIG. 4 shows a cutaway side view of a hard drive built according to the present invention in which a drive motor drives a spindle attached to the hard drive media platters that are sandwiched between the read/write platters, which, in turn, are attached to a support frame;

FIG. 5 is another plan view of the read/write platter according to the present invention showing a read/write head pattern including a sub-processing addressing unit for communicating with the read/write heads; and

FIG. 6 is cutaway side view of a single read/write head platter and two media platters, the spindle attached to the two media platters, the frame for supporting the read/write heads, as well as two associated sub-processing address units located on both sides of the read/write head platter.

### DESCRIPTION OF A REPRESENTATIVE EMBODIMENT

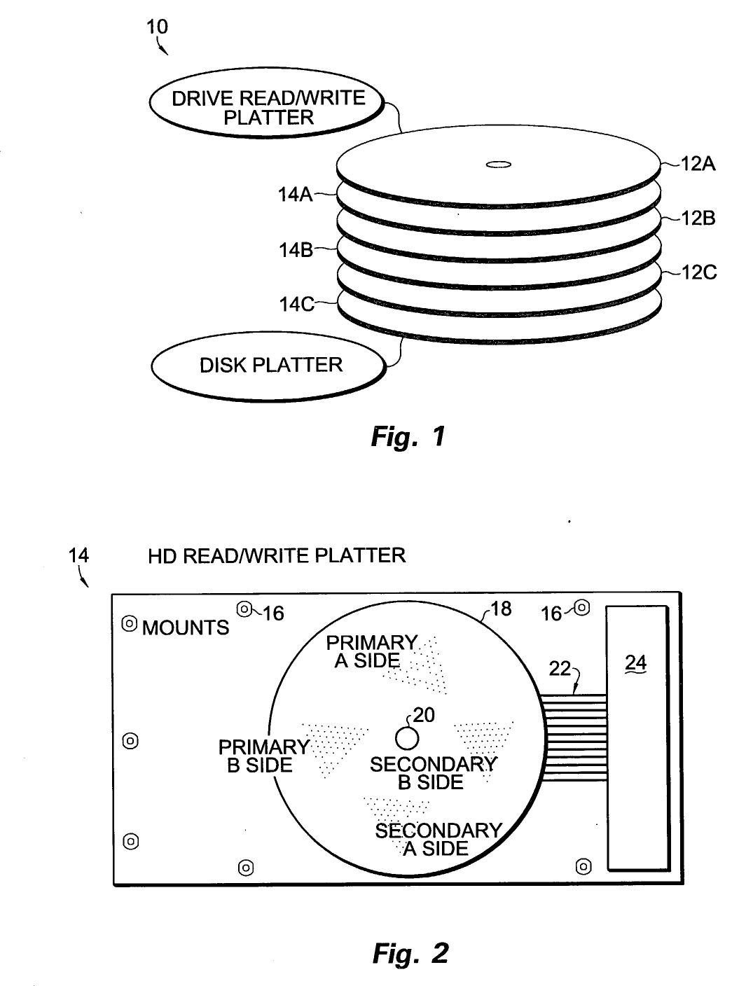

Referring now to FIG. 1, a side angle view of a highly simplified version of the static head assembly 10 of the present invention is shown. There are three static read/write platters 12A, 12B and 12C interleaved with three rotating media platters 14A, 14B, and 14C. A simplified read/write head pattern is visible on read/write platters 12A, 12B, and 12C.

Referring now to FIG. 2, a plan view of a static read/write platter 14 is shown in greater detail. Read/write platter 14 is rectangular for mounting in a frame, which is described in further detail below. There are several mounts 16 distributed around the periphery of read/write platter 14 for securing the platter to the frame. The circular portion 18 of the read/write platter corresponds to the dimensions of the interleaved rotating circular media platters. A spindle hole 20 is shown for allowing access to a spindle coupled to the media platters. The circular portion 18 also includes the read/write head patterns, which are spaced apart to minimize interference during reads and writes. Thus, the “a-side” or top side head pattern, as well as the “b-side” or bottom side head pattern, are both shown in FIG. 2. The read/write heads are coupled to sub-system control circuitry 24 placed at the edge of platter 14 via a series of busses 22.

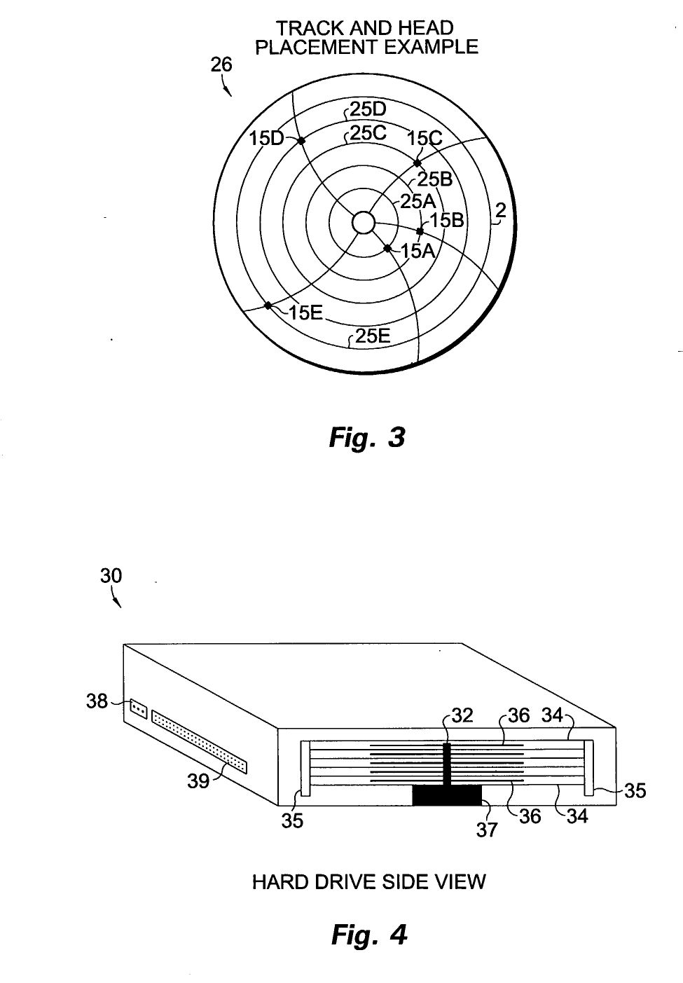

Referring now to FIG. 3, a plan view of a composite read/write platter and media platter 26 is shown to illustrate the track and read/write head placement. In the example of FIG. 3 a non-moving read/write drive head 15A, 15B, 15C, 15D, and 15E is placed directly above or below a corresponding track 25A, 25B, 25C, 25D, and 25E on a moving hard drive media platter. This allows for very quick retrieval of data and placing of data on the hard drive media platter. It is apparent from an inspection of FIG. 3 that all of the data on the media platter can be accessed on all tracks as the media platter is rotated relative to the static read/write platter.

Referring now to FIG. 4, a cutaway side view of a hard drive 30 built according to the present invention is shown. A drive motor 37 drives a spindle 32 attached to the hard drive media platters 36 that are sandwiched between the read/write platters 34. In the hard drive 30 shown in FIG. 4 there are six read/write platters 34 and five media platters 36. This ensures that each media platter 36 can be accessed from the top and bottom. Each read/write platter 34 is securely attached to a support frame 35. Power connections 38 and data connections 39 are shown on an adjacent side of hard drive 30.

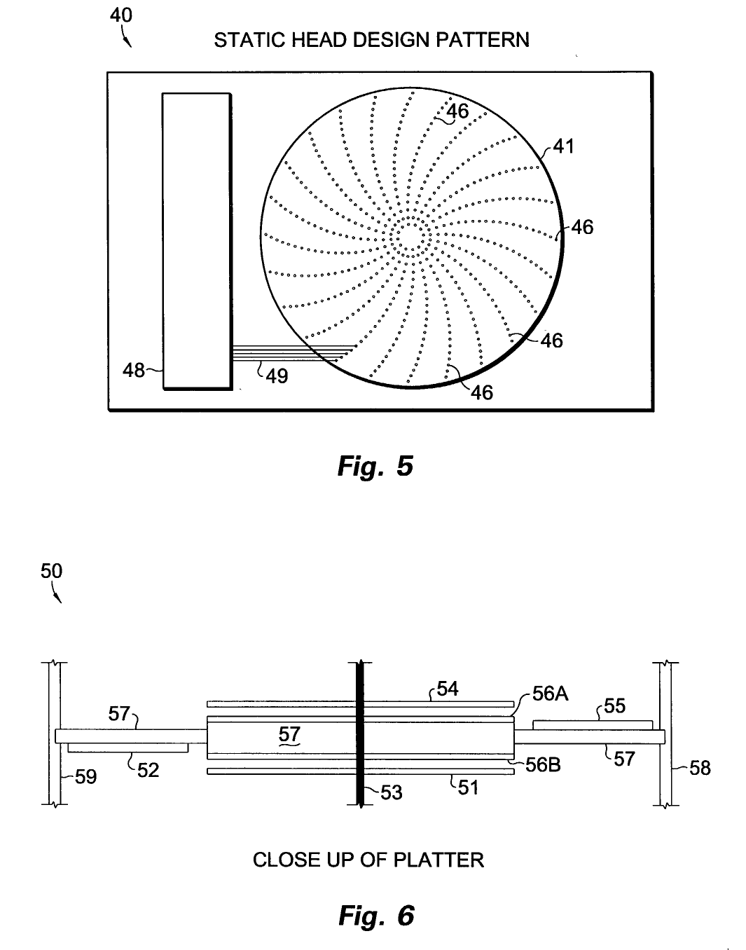

Referring now to FIG. 5, a more detailed plan view of the read/write platter 40 according to the present invention is shown. A spiral read/write head pattern includes read/write heads 46 arranged in multiple arms extending from the center of the circular portion 41 of the platter 40. Read/write platter 40 includes a sub-processing addressing unit 48 for communicating with the read/write heads through a set of electrical busses 49. The static read/write head platter 40 is ideally made of a light and strong material, such as plastic, polymer, or carbon fiber. The read/write heads 46 on read/write head platter 40 are either embedded directly into the material of the platter, or can be part of a thin layer of material that attaches directly to the head platter itself.

Referring now to FIG. 6, a portion 50 of the hard disk assembly according to the present invention is shown. The cutaway side view of FIG. 6 shows in greater detail a single read/write head platter 57 and two associated media platters 51 and 54. The read/write heads are contained in layers 56A and 56B on the upper and lower surfaces of head platter 57. A spindle 53 passes through head platter 57 and is attached to the two media platters 51 and 54. A frame 58, 59 is shown for supporting the read/write head platter 57, as well as two associated sub-processing address units 52 and 55 located on both sides of the read/write head platter 57.

It has been shown that a hard disk drive according to the present invention replaces the arm assembly in a convention hard disk drive and includes at least one static read/write head platter and at least one rotating media platter in communication with, generally parallel to, and spaced apart from the read/write head platter. In a preferred embodiment, the hard disk drive includes N media platters and N+1 static read/write head platters, wherein N is an integer, so that each media platter may be accessed from the top or bottom surfaces. The hard disk drive of the present invention includes static read/write head platters that include a multiplicity of read/write heads on the upper surface of the platter, the lower surface of the platter, or both. To minimize interference, each static read/write head platter ideally includes a spiral arm pattern of read/write heads. Each static read/write head platter includes a sub-assembly address unit for controlling the operation of the read/write heads associated with the read/write head platter. The hard disk drive of the present invention further includes a support frame for securing the static read/write head platters, and a motor and spindle attached to each of the media platters. The substrate of each static read/write head platter can be fabricated from plastic, polymer, and carbon fibers.

Having described and illustrated the principle of the invention in a preferred embodiment thereof, it is appreciated by those having skill in the art that the invention can be modified in arrangement and detail without departing from such principles. I therefore claim all modifications and variations coming within the spirit and scope of the following claims.

I claim:

1. A hard disk drive comprising:
at least one static read/write head platter; and
at least one rotating media platter generally parallel to and spaced apart from the read/write head platter.

2. The hard disk drive of claim 1 comprising N media platters and N+1 static read/write head platters.

3. The hard disk drive of claim 1 in which each static read/write head platter comprises a plurality of read/write heads on an upper surface of the platter.

4. The hard disk drive of claim 1 in which each static read/write head platter comprises a plurality of read/write heads on a lower surface of the platter.

5. The hard disk drive of claim 1 in which each static read/write head platter comprises a plurality of read/write heads on an upper and lower surface of the platter.

6. The hard disk drive of claim 1 in which each static read/write head platter comprises a spiral pattern of read/write heads.

7. The hard disk drive of claim 1 in which each static read/write head platter further comprises a sub-assembly address unit for controlling the operation of a plurality of read/write heads associated with the read/write head platter.

8. The hard disk drive of claim 1 further comprising a support frame for securing the static read/write head platters.

9. The hard disk drive of claim 1 further comprising a motor and spindle attached to each of the media platters.

10. The hard disk drive of claim 1 in which each static read/write head platter comprises a substrate fabricated from a group of materials including plastic, polymer, and carbon fibers.

11. A hard disk drive comprising:
at least one static read/write head platter; and
at least one rotating media platter in communication with the read/write head platter.

12. The hard disk drive of claim 11 comprising N media platters and N+1 static read/write head platters.

13. The hard disk drive of claim 11 in which each static read/write head platter comprises a plurality of read/write heads on an upper surface of the platter.

14. The hard disk drive of claim 11 in which each static read/write head platter comprises a plurality of read/write heads on a lower surface of the platter.

15. The hard disk drive of claim 11 in which each static read/write head platter comprises a plurality of read/write heads on an upper and lower surface of the platter.

16. The hard disk drive of claim 11 in which each static read/write head platter comprises a spiral pattern of read/write heads.

17. The hard disk drive of claim 11 in which each static read/write head platter further comprises a sub-assembly address unit for controlling the operation of a plurality of read/write heads associated with the read/write head platter.

18. The hard disk drive of claim 11 further comprising a support frame for securing the static read/write head platters.

19. The hard disk drive of claim 11 further comprising a motor and spindle attached to each of the media platters.

20. The hard disk drive of claim 11 in which each static read/write head platter comprises a substrate fabricated from a group of materials including plastic, polymer, and carbon fibers.
